(19) United States
(12) Patent Application Publication
(10) Pub. No.: US 2008/0204235 A1
(43) Pub. Date: Aug. 28, 2008

(54) Fiber optic cable with integral radio frequency identification system

(75) Inventor: Thomas C. Cook, Woodstock, GA (US)

Correspondence Address: KING & SPALDING LLP, 1180 PEACHTREE STREET, ATLANTA, GA, 30309-3521, US

(73) Assignee: Superior Essex Communications LP, Atlanta, GA (US)

(21) Appl. No.: 11/709,384

(22) Filed: Feb. 22, 2007

(51) Int. Cl. H04B 1/59

(52) U.S. Cl. 340/572.1

(57) ABSTRACT

A communication cable, such as an optical fiber cable, can comprise radio frequency identification (“RFID”) elements that facilitate locating and identifying the cable. The RFID elements can provide information about the cable from a remote location, for example when the cable is spooled in a warehouse, buried underground, suspended overhead, or installed in a cable tray. The RFID elements can be attached at defined locations along a plastic tape within the cable. Each RFID element can comprise an antenna that extends lengthwise along the tape and/or circuit traces or other components that are imprinted on the tape. Each RFID element can have a unique code or address, thereby providing a record of manufacturing parameters that are specific to that cable. Also, the unique code can be specific to an incremental length of cable. Accordingly, the RFID elements can yield information about each fiber segment of the cable.

### FIELD OF THE INVENTION

The present invention relates to communication cables with electrical, twisted pair, fiber optical, or other conductors and any combination thereof. More specifically, the present invention relates to incorporating radio frequency identification (“RFID”) elements at defined locations along a plastic tape within the cable for locating and identifying the cable from a remote location, for example when the cable is spooled in a warehouse, buried underground, suspended overhead, or installed in a cable tray.

### BACKGROUND

As the desire for enhanced communication escalates, electrical and fiber optical data transmission cables are deployed in ever denser numbers within conduits, cable trays, wiring closets, crawl spaces, ceilings, buried underground and strung from poles. Traditionally, identifying one cable from another or ascertaining information about a cable required the user to obtain an outside view of the jacket of a cable to attempt to read the manufacturer's markings on the cables. Such traditional markings are usually printed intermittently on the outside of a cable jacket.

Intermittent jacket printing is spaced out along the outside jacket of the cable with spacing of several inches, a foot, or more between markings. Obtaining visual access to the jacket printing of a cable is not always possible. For example, when the cable is buried underground, deployed in a densely packed conduit or cable try, or the cable is still on its spool in a warehouse.

Furthermore, printing on the outside jackets of cables is often very small due to limited space on the jacket. Additionally, printing on the jacket may become damaged or scratch off completely during installation, wear, or from exposure to light, water, vapors, or chemicals. These difficulties in accessing identifying information on a cable add time, expense, and complication to field operations on deployed communication cables.

Accordingly, there is a need in the art for efficiently marking electrical or fiber optical communication cables so that the cable information can be utilized from a distance without having to unspool any portion of a spooled cable, dig up buried cable, unbundle cable trays or otherwise directly handle individual cables. There is a further need in the art for efficiently identifying the length of a cable or cable segment from a distance.

### SUMMARY

The present invention supports an optical fiber or a cable with embedded radio frequency identification (“RFID”) elements that can facilitate locating and identifying the cable. The RFID elements or transponders can provide information about the cable to a remote RFID reader without directly accessing or handling the cable. This can be particularly useful in situations such as when the cable is spooled in a warehouse, buried underground, suspended overhead, or installed in a cable tray.

RFID is an automatic identification method, relying on storing and remotely retrieving data using devices called RFID tags or transponders. An RFID tag is an object that can be attached to or incorporated into a product for the purpose of identification using radio waves. Chip-based RFID tags contain integrated circuit chips and antennas. Passive RFID tags typically operate without an internal power source.

The RFID elements can be attached at defined locations along a tape within the cable. Each RFID element can comprise an antenna that extends lengthwise along the tape and/or circuit traces or other components that are imprinted on the tape. Each RFID element can have a unique code or address, thereby providing a record of manufacturing parameters that are specific to that cable. Also, the unique code can be specific to an incremental length of cable. Accordingly, the RFID elements can yield information about each segment of the cable.

The tape can be a flat substrate that can be formed around a cable core prior to the outer protective jacket being applied to the cable. A cable can have the tape applied longitudinally along the core of the cable, just underneath the outer jacket or sheath. This can be accomplished either by roll forming the tape around the cable core, or running the tape straight along an axis of the core. This tape can have RFID transponders along its length. An RFID transponder can report a key number that uniquely identifies the cable. Alternatively, there can be an additional number to indicate the length of the RFID tape at the point of a given RFID transponder. An RFID reader can be used to read an RFID transponder within the cable and provide information about that cable.

The discussion of RFID cable and optical fiber identification presented in this summary is for illustrative purposes only. Various aspects of the present invention may be more clearly understood and appreciated from a review of the following detailed description of the disclosed embodiments and by reference to the drawings and the claims that follow. Moreover, other aspects, systems, methods, features, advantages, processes, and objects of the present invention will become apparent to one with skill in the art upon examination of the following drawings and detailed description. It is intended that all such aspects, systems, methods, features, advantages, processes, and objects are to be included within this description, are to be within the scope of the present invention, and are to be protected by the accompanying claims.

### BRIEF DESCRIPTION OF THE DRAWINGS

FIG. 1A illustrates a partially unrolled spool of RFID tape according to one exemplary embodiment of the present invention.

FIG. 1B illustrates a cross-sectional view of a cable comprising an RFID tape beneath the outer jacket according to one exemplary embodiment of the present invention.

FIG. 2 illustrates a portion of RFID tape supporting RFID transponders and associated antennas according to one exemplary embodiment of the present invention.

FIG. 3 shows a logical flow diagram representing a process for identifying cables using an RFID tape integrated into the cable according to one exemplary embodiment of the present invention.

Many aspects of the invention can be better understood with reference to the above drawings. The elements and features shown in the drawings are not to scale, emphasis instead being placed upon clearly illustrating the principles of exemplary embodiments of the present invention. Moreover, certain dimension may be exaggerated to help visually convey such principles. In the drawings, reference numerals designate like or corresponding, but not necessarily identical, elements throughout the several views.

### DETAILED DESCRIPTION OF EXEMPLARY EMBODIMENTS

The present invention supports an optical fiber or a cable with embedded radio frequency identification elements that can facilitate locating and identifying the cable. The RFID elements or transponders can provide information about the cable to a remote RFID reader without directly accessing or handling the cable. This can be particularly useful in situations such as when the cable is spooled in a warehouse, buried underground, suspended overhead, or installed in a cable tray.

The RFID elements can be attached at defined locations along a plastic tape within the cable. Each RFID element can comprise an antenna that is imprinted upon the tape and may extend lengthwise along the tape. The RFID element can also include circuit traces or other components that are imprinted on the tape. Each RFID element can have a unique code or address, thereby providing a record of manufacturing parameters that are specific to that cable. Also, the unique code can be specific to an incremental length of cable. Accordingly, the RFID elements can yield information about each segment of the cable or provide an efficient mechanism for measuring the length of the cable or a segment of the cable.

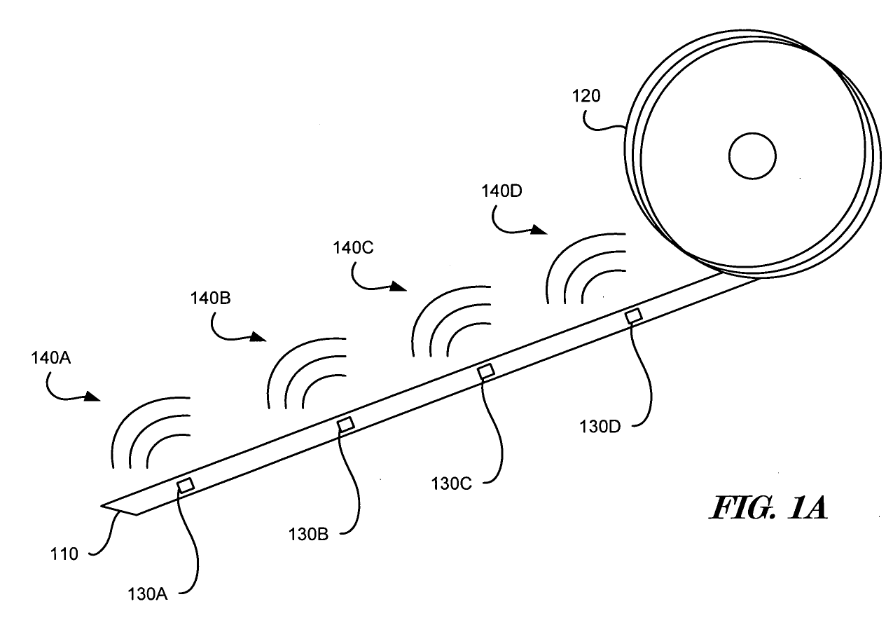

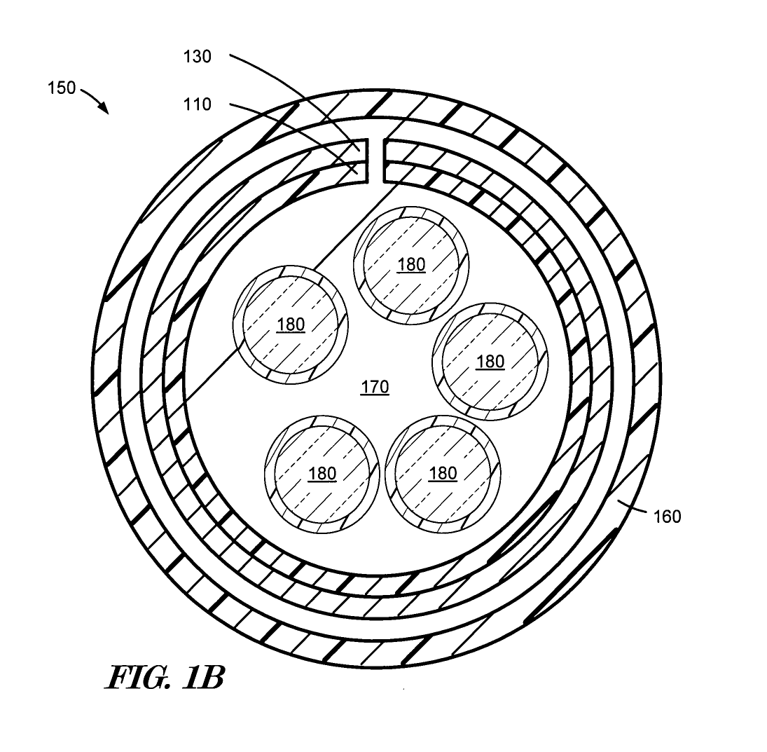

A system and method for identifying cables and optical fibers comprising embedded RFID transponders will now be described more fully hereinafter with reference to FIGS. 1-3, which describe representative embodiments of the present invention. The invention can be embodied in many different forms and should not be construed as limited to the embodiments set forth herein; rather, these embodiments are provided so that this disclosure will be thorough and complete, and will fully convey the scope of the invention to those having ordinary skill in the art. Furthermore, all “examples” or “exemplary embodiments” given herein are intended to be non-limiting, and among others supported by representations of the present invention.

Turning now to the drawings, in which like reference numerals refer to like (but not necessarily identical) elements, FIG. 1A illustrates a partially unrolled spool of RFID tape according to one exemplary embodiment of the present invention. The RFID tape 110 can serve as a substrate supporting RFID transponders 130 that are spaced along the length of the RFID tape 110. The RFID tape 110 can be supplied on a roll, a reel, or a spool 120. The RFID transponders 130 respond to interrogation by an RFID reader or scanner (not illustrated) by emitting RF signals 140 that contain information readable by the RFID reader or scanner.

The substrate of the RFID tape 110 can be any non-conductive material, such as a plastic or polymer film or sheet. The RFID transponders 130 can comprise circuitry or antennas formed by conductive material that is evaporated onto, painted onto, printed onto, or otherwise attached to the substrate of the RFID tape 110. The RFID tape 110 may also comprise ridges, mounting holes, adhesives, tie wraps, other mechanisms, or any combination thereof for enabling the RFID tape 110 to attach or adhered to cables, fibers conduits, cable trays, hoses, pipes or any other objects for identification or linear measurement.

The RFID transponders 130 can be positioned upon the substrate to allow an RFID scanner or reader to interrogate the RFID tape 110 over much or all of its length. For example, they can be positioned close enough to one another as to provide substantial coverage of the length of the RFID tape 110 such that the RFID tape 110 (or a cable comprising the tape) can be identified along its length. The positioning of the RFID transponders 130 can also relate to a length interval of the RFID tape 110. For example, RFID transponder 130B can be located five meters away from RFID transponder 130A, and then the corresponding RF signals 140B, 104A emitted by the RFID transponders 130 can indicate that one of the transponders is five meters from another of the transponders. Such spacing of the RFID transponders 130 and corresponding position information contained with in the RF signals 140 can be continued along the length of the RFID tape 110. In this manner, responses from more then one RFID transponder 130 can be compared to ascertain the relative positions or length of tape between the set of RFID transponders 130. Such comparison between the RF signals 140 from the RFID transponders 130 may involve comparing information encoded with the radio frequency ID, the power of the response signal 140, the timing of the response signal 140, or any other information or radio propagation parameters. The comparison may also be based upon the ability of the RFID transponders 130 to respond to varying levels of interrogating power from the RFID scanner or reader.

Turning now to FIG. 1B, the figure illustrates a cross-sectional view of a cable comprising an RFID tape beneath the outer jacket according to one exemplary embodiment of the present invention. The RFID tape 110 can be positioned within a cable 150 to allow the cable 150 to be identified while on a spool in inventory or after the cable 150 is deployed, without the need to dig up or unbundle the cable 150. The cable 150 can have the RFID tape 110 applied longitudinally along the core 170 of the cable 150, just underneath the outer jacket 160. This can be accomplished either by roll forming the RFID tape 110 around the cable core 170, or running the RFID tape 110 straight along an axis of the core 170 within a larger cable 150. The RFID transponders 130 can be positioned upon the RFID tape 110 as discussed in relationship to FIG. 1A.

Signal conductors 180 within the core 170 of the cable 150 can be insulated electrical conductors, twisted pairs, optical fibers, or any other type of signal conductors. The signal conductors 180 within the core 170 of the cable 150 may be in any number such as one, two, three, four, five, six, seven, eight, or more. The signal conductors 180 within the core 170 of the cable 150 may be twisted in pairs, threes, other groupings, and may also be twisted all together. Shielding, filler, cross-filler, or other cable elements may also be positioned with the core 170 of the cable 150.

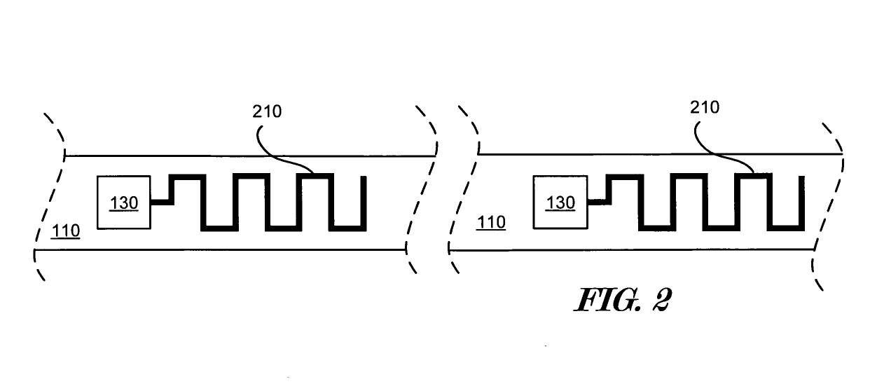

Turning now to FIG. 2, the figure illustrates a portion of RFID tape supporting RFID transponders and associated antennas according to one exemplary embodiment of the present invention. The RFID tape 110 can support RFID transponders 130 that can be periodically positioned along the length of the RFID tape 110. For example, each RFID transponder 130 may be two meters from the previous one such that they occur at pre-determined distances along the length of the RFID tape 110. Each RFID transponder 130 can comprise an antenna 210. An antenna 210 and other circuitry or circuit wiring supporting an RFID transponders 130 can be formed by conductive material that is evaporated onto, painted onto, printed onto, or otherwise attached to the substrate of the RFID tape 110.

The antenna 210 of an RFID transponder 130 can be a patch antenna, a dipole, a coil, a flattened coil, a monopole, or other type of antenna. A given RFID transponder 130 may comprise more than one antenna 210.

The type of information encoded within the RFID transponder 130 may include a unique identified for the specific cable 150, information about the manufacturer, the date of manufacture, the type of cable 150, the lot number of the cable 150, the serial number, physical characteristics of the cable 150, or any other information that is desired to be associated with the cable 150. Also, the information within the RFID transponder 130 can indicate length or positional along the cable 150.

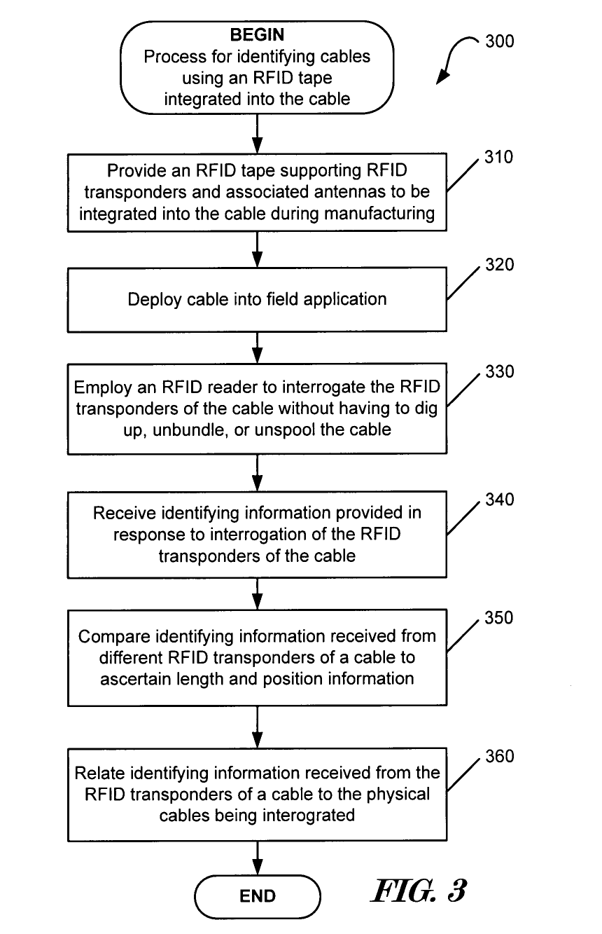

Turning now to FIG. 3, the figure shows a logical flow diagram 300 representing a process for identifying cables using an RFID tape 110 integrated into the cable according to one exemplary embodiment of the present invention. Certain steps in the processes or process flow described in all of the logic flow diagrams referred to below must naturally precede others for the invention to function as described. However, the invention is not limited to the order of the steps described if such order or sequence does not alter the functionality of the invention. That is, it is recognized that some steps may be performed before, after, or in parallel with other steps without departing from the scope or spirit of the invention.

In Step 310, the cable is manufactured with an RFID tape 110 integrated into the cable. The RFID tape 110 can support RFID transponders 130 and RFID transponder antennas 210. Next, in Step 320, the cable 150 can be deployed into a field application. Deployment of the cable 150 may include burying the cable 150; running the cable 150 through a conduit underground or within walls, floors, or ceilings; placing the cable 150 into a cable tray; and/or placing the cable 150 within a riser or plenum environment. In any of these cases, the cable 150 may be part of a structured cable or may be bundled along with other cables or along pipes or conduits.

In Step 330, an RFID reader or scanner can be used to interrogate the RFID transponders 130 embedded within the cable 150. Through the use of RF signals 140, the RFID transponders 130 can be interrogated without digging up the cable 150, unbundling it from a cable tray, plenum or riser bundle, or unspooling the cable 150. Next, in Step 340, the RF signal 140 responses from the RFID transponders 130 provide information back to the RFID scanner or reader in response to the interrogation make in Step 330.

In Step 350, information from the responses of more then one RFID transponder 130 can be compared to ascertain the relative positions or length of tape between the set of RFID transponders 130. Such comparison between the RF signals 140 from the RFID transponders 130 may involve comparing information encoded with the radio frequency ID, the power of the response signal 140, the timing of the response signal 140, or any other information or radio propagation parameters. The comparison may also be based upon the ability of the RFID transponders 130 to respond to varying levels of interrogating power from the RFID scanner or reader.

In Step 360, information received from the RFID transponders 130 within a cable 150 are related to the physical cables 150 involved to allow for identification, measurement, inventory, cataloging, or other data recording or processing based on the deployed cable 150. Process 300 ends after Step 360.

From the foregoing, it will be appreciated that an embodiment of the present invention overcomes the limitations of the prior art. Those skilled in the art will appreciate that the present invention is not limited to any specifically discussed application and that the embodiments described herein are illustrative and not restrictive. From the description of the exemplary embodiments, equivalents of the elements shown therein will suggest themselves to those skilled in the art, and ways of constructing other embodiments of the present invention will suggest themselves to practitioners of the art. Therefore, the scope of the present invention is to be limited only by the claims that follow.

What is claimed is:

1. A cable comprising:
a nonconductive tape extending a length of the cable; and
a plurality of radio frequency identification transponders disposed periodically along a length of the tape, wherein the radio frequency identification transponders report information related to the cable.

2. The cable of claim 1, further comprising:
one or more signal conductors extending the length of the cable; and
an outer jacket disposed around the signal conductors, wherein the tape is positioned adjacent to the signal conductors and within the outer jacket.

3. The cable of claim 1, wherein the radio frequency identification transponders comprise one or more antennas positioned upon the tape.

4. The cable of claim 1, wherein the information related to the cable indicates a manufacturer of the cable.

5. The cable of claim 1, wherein the information related to the cable indicates a date of manufacture of the cable.

6. The cable of claim 1, wherein the information related to the cable indicates a unique identifier of the cable.

7. The cable of claim 1, wherein the information related to the cable is unique to each radio frequency identification transponder of the cable, the unique information providing a determination of a position of a respective transponder along the length of the cable.

8. A linear identification tape comprising:
a flexible, non-conductive substrate extending a length of the linear identification tape; and
a plurality of radio frequency identification transponders disposed periodically along a length of the substrate, wherein the radio frequency identification transponders report identification information.

9. The linear identification tape of claim 8, wherein the radio frequency identification transponders comprise one or more antennas, the antennas positioned upon the substrate.

10. The linear identification tape of claim 8, wherein the identification information comprises a unique identifier.

11. The linear identification tape of claim 8, wherein the identification information is unique to each radio frequency identification transponder, the unique identification information facilitating a determination of a position of a respective transponder along the length of the substrate.

12. A process for identifying a cable comprising the steps of:
providing an RFID tape integrated into the cable, the RFID tape supporting RFID transponders and associated antennas;
employing an RFID reader to interrogate the RFID transponders supported by the RFID tape; and
relating identifying information received from the RFID transponders in response to the interrogation by the RFID reader.

13. The process of claim 12, further comprising the step of deploying the cable into the field, wherein the interrogation step comprises interrogating the cable from a remote location.

14. The process of claim 12, wherein the identifying information comprises one of a unique identifier, a manufacturer identifier, a lot number, and a cable type.

15. A process for determining a length of a cable, comprising the steps of:
employing an RFID reader to interrogate a plurality of RFID transponders attached to a tape disposed in the cable; and
comparing information received from the plurality of RFID transponders to ascertain a length between at least two of the plurality of RFID transponders.

16. The process of claim 15, further comprising the step of deploying the cable into the field, wherein the interrogation step is accomplished while the cable remains in the field.

17. The process of claim 15, wherein the information comprises position information unique to each of the plurality of RFID transponders.

18. The process of claim 15, wherein the step of comparing further comprises comparing data within the information.

19. The process of claim 15, wherein the step of comparing further comprises comparing an arrival time of a first RFID response with an arrival time of a second RFID response.

20. The process of claim 15, wherein the step of comparing further comprises comparing a power level of a first RFID response with a power level of a second RFID response.
